(19) United States
(12) Patent Application Publication
(10) Pub. No.: US 2013/0132003 A1
(43) Pub. Date: May 23, 2013

(54) METHOD FOR DETERMINING A RESULTING TOTAL MASS FLOW TO AN EXHAUST GAS MASS FLOW SENSOR

(71) Applicants: Andres Toennesmann, Aachen (DE); Karsten Grimm, Aachen (DE); Sven Nigrin, Duesseldorf (DE)

(72) Inventors: Andres Toennesmann, Aachen (DE); Karsten Grimm, Aachen (DE); Sven Nigrin, Duesseldorf (DE)

(21) Appl. No.: 13/813,654

(22) PCT Filed: Jul. 5, 2011
(86) PCT No.: PCT/EP2011/061324

§ 371 Date: Feb. 1, 2013

(30) Foreign Application Priority Data
Aug. 3, 2010 (DE) 10 2010 033 175.9

(51) Int. Cl. G06F 17/00; G01F 1/86

(52) U.S. Cl. CPC G06F 17/00; G01F 1/86
USPC 702/45; 701/102

(57) ABSTRACT

A method for determining a resulting total mass flow to an exhaust gas mass flow sensor involves providing an exhaust gas mass flow sensor comprising a first sensor element and a second sensor element. The second sensor element comprises a first temperature sensor and a second temperature sensor arranged in a row in an exhaust flow direction. A specific heat output is determined at the exhaust gas mass flow sensor with the first sensor element and the second sensor element. A value of a summed mass flow is determined from a stored first characteristic map, a specific heat output being a function of the value. A normalized temperature gradient is determined. A back flow portion is determined from a stored second characteristic map, the back flow portion being a function of the specific heat output in dependence on the normalized temperature gradient. The resulting total mass flow is determined.

The present invention refers to a method for determining a resulting total mass flow to an exhaust gas mass flow sensor, as well as to an exhaust gas mass flow sensor for carrying out this method.

In order to meet the ever increasing demands stipulated by new exhaust gas standards in the field of motor vehicles, a number of measures internal to the engine, such as exhaust gas after treatment, have become integral parts of present and future engine concepts. However, the full potential of such measures, such as the cooled exhaust gas recirculation, for instance, can only be exploited if a corresponding tuning of the introduced exhaust gas mass flow to the respective operational states of the engine is made. Thereby, higher requirements are made to engine control and in particular to the sensor system used for that purpose.

For the determination of the mass flow in a pipe through which hot exhaust gas flows, exhaust gas mass flow sensors are often used that operate according to the anemometric principle.

In this context, it is one of the essential challenges to detect exhaust gas pulsations of the exhaust gas mass flow which are substantially caused by charge changing processes in the internal combustion engine, as well as the correct balancing of the exhaust gas mass flow based thereon, which requires a correct detection of the direction.

Exhaust gas mass flow sensors are known from prior art by means of which an exhaust gas mass flow is to be measured as a function of the flow direction or flow direction changes.

Such an exhaust gas mass flow sensor is known from DE 10 2006 030 786 A1. The exhaust gas mass flow sensor disclosed therein comprises two sensor elements arranged in a row, where the second sensor element itself is formed by two temperature sensors arranged in a row. The first sensor element arranged in the flow direction is a temperature measuring element configured as a platinum thin-film resistor. This first sensor element measures the temperature of the exhaust gas. The second sensor element, arranged downstream thereof in the flow direction, is a heating element that is also configured as a platinum thin-film resistor. This second sensor element is heated to an elevated temperature by electrical heating so that, substantially by thermal convection, a heat transfer to the exhaust gas mass flow occurs. By measuring the temperature change or by measuring the power input necessary to keep the temperature of the second sensor element constant, an exhaust gas mass flow can be obtained by the use of appropriate algorithms. By arranging two separate temperature sensors on the second sensor element, it becomes possible to detect the direction of the exhaust gas mass flow.

However, prior art does not disclose how such a detection of the direction is achieved using such an exhaust gas mass flow sensor; in particular, it is not disclosed how a determination is performed in order to obtain a resulting total mass flow in the event of exhaust gas pulsations occurring.

Exhaust gas mass flow sensors are typically thermally inert sensors, i.e. due to the material thickness used for the resistor elements, the determination of the exhaust gas temperature, in particular the temperature of exhaust gas with exhaust gas pulsations, is slower than the pulsation frequency of the engine. For exhaust gas pulsation having a back flow portion, the averaged heat output of the second sensor element is significantly increased, without performing a detection of the fluctuations in the mass flow caused by exhaust gas pulsations of the engine. As a consequence, the exhaust gas mass flow sensor outputs a wrong exhaust gas mass flow value. Further, the temperatures occurring at the resistor elements over time differ from each other depending on the back flow portion.

Therefore, it is an object of the invention to provide a method for determining a resulting total mass flow at an exhaust gas mass flow sensor, which allows a more exact determination of the exhaust gas mass flow when exhaust gas pulsations occur, as well as an exhaust gas mass flow sensor for carrying out this method.

This object is achieved according to the invention with a method as defined in claim 1, as well as with an exhaust gas mass flow sensor for carrying out this method as defined in claim 6.

According to the present method for determining a resulting total mass flow at an exhaust gas mass flow sensor, it is provided in a first method step to determine the specific heat output at an exhaust gas mass flow sensor working according to the anemometric principle and comprising two sensor elements arranged in a row in the flow direction. From a stored first characteristic map an amount of a summed mass flow \dot{M}_{Sum}=|\dot{M}_{for}|+|\dot{M}_{back}| is calculated, where \dot{M}_{for} is the mass flow in the defined flow direction of the exhaust gas and \dot{M}_{back} is the mass flow opposite to the defined flow direction of the exhaust gas. In this first characteristic map, the specific heat output is defined as a function of this amount. In a next method step, a normalized temperature gradient is calculated, the temperature gradient being defined as the ratio of the temperature difference between a measured temperature value of a second and a first temperature sensor of the second sensor element to the temperature difference between a temperature value calculated from the measured temperature values of the second sensor element and a measured temperature value of the first sensor element. From a stored second characteristic map, a back flow portion

$$γ = \frac{{\dot{M}}_{back}}{{\dot{M}}_{for}}$$

is calculated. The back flow portion is a function of the specific heat output and is further dependent on the normalized temperature gradient. Using the formula

$${\dot{M}}_{restot} = {\dot{M}}_{Sum} \times \frac{( 1 - γ )}{( 1 + γ )} ,$$

the resulting total mass flow of the exhaust gas mass flow sensor can be determined in a last method step.

In the presence of exhaust gas pulsations, the method allows a more exact and reliable determination of the exhaust gas mass flow.

The object is also achieved with an exhaust gas mass flow sensor for carrying out the method, comprising two sensor elements arranged in a row in the flow direction, the second sensor element itself comprising two temperature sensors arranged in a row in the flow direction, and the exhaust gas mass flow sensor further comprising an evaluation unit in which the first and second characteristic maps are stored.

By providing two temperature sensors on the second sensor element, it becomes possible to determine the temperature distribution so that the fluctuations of the exhaust gas mass flow caused by the exhaust gas pulsations of the engine can be detected. Using the characteristic map stored in the evaluation unit of the exhaust gas mass flow it becomes possible to correct the measured values as a function of the back flow portion of the exhaust gas mass flow value, so that a more exact exhaust gas mass flow value can be calculated. Further, the evaluation unit of the exhaust gas mass flow sensor allows using the calculated variables together with state variables of the engine, such as, for example, the air ratio lambda or the gas pressure, so as to guarantee an optimized engine control.

In a preferred embodiment of the method, in order to determine the specific heat output, the first sensor element determines the temperature of the exhaust gas and the second sensor element downstream thereof is heated to a higher temperature with respect to the exhaust gas flowing past the same, so that the exhaust gas flowing past the second sensor element causes a loss of heat. Here, the specific heat output is defined as the ratio of an output from the second sensor element to the temperature difference between the second and the first sensor elements. Using this exhaust gas mass flow sensor configured according to the anemometric principle, it is possible to determine an exhaust gas mass flow with the help of appropriate algorithms.

Preferably, the temperature value at the second sensor element is formed from an arithmetic average of the respective measured temperature values of the first and the second temperature sensors. This is reasonable on a physical level, if both temperature sensors of the second sensor element are symmetrically designed.

Preferably, the first characteristic map is determined by an experimental determination of the specific heat output from a defined summed mass flow. For this purpose, the exhaust gas mass flow in a device is adjusted such that the exhaust gas to be measured flows through the device without a back flow portion, i.e. there is a pure forward flow. Based on the different exhaust gas mass flows predefined in the experiment, the dependence of the specific heat output on the summed mass flow can then be determined. Thus, the summed mass flow is a value of the forward flow portion and of the back flow portion.

Preferably, the second characteristic map is obtained by experimentally determining the specific heat output for a defined back flow portion in dependence on the temperature gradient. In this context it applies that for a pure pulsation flow, i.e. the resulting total mass flow is zero, no temperature gradient exists between the two temperature sensors at the second sensor element, i.e. the difference is zero, so that the back flow portion has a value of one. In contrast, for a pure forward flow, i.e. the back flow portion is near zero, the temperature gradient becomes a maximum, i.e. it becomes greater than zero. All states in which the resulting total mass flow is greater than zero can be preset in a corresponding device by adjusting the back flow portion in the exhaust gas mass flow, so that the above mentioned dependence can be calculated from the established temperature difference between the two temperature sensors and the established specific heat output.

Hereinafter, an embodiment of an exhaust gas mass flow sensor is illustrated with reference to a drawing, which sensor is suitable for carrying out the method of the invention. Further, diagrams are illustrated that show essential functions of the present method.

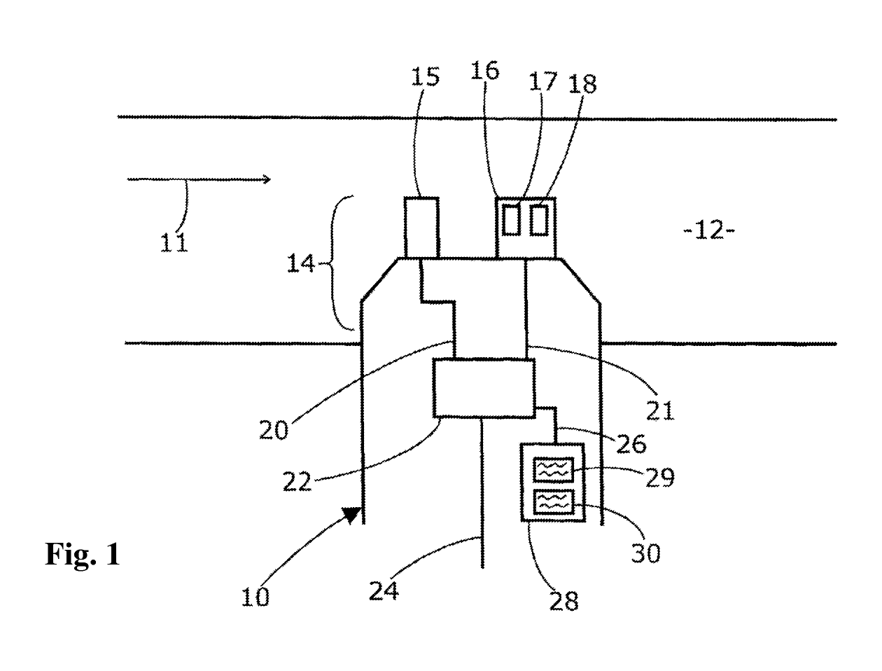

FIG. 1 is a schematic illustration of an exhaust gas mass flow sensor.

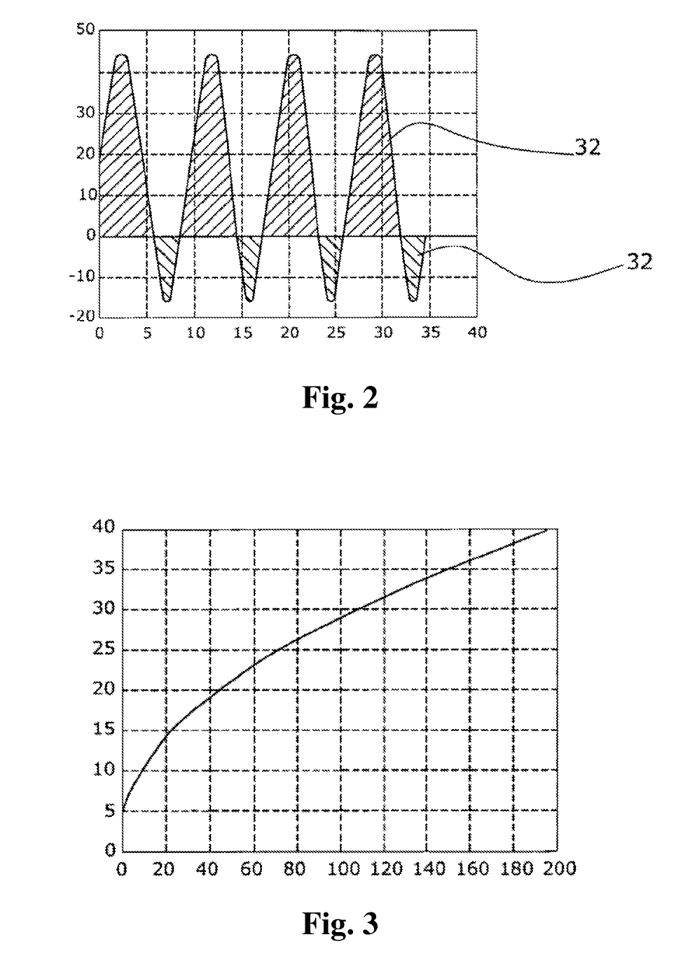

FIG. 2 illustrates a plot of an exhaust gas mass flow with a back flow portion as a function of time.

FIG. 3 illustrates a function of a first characteristic map.

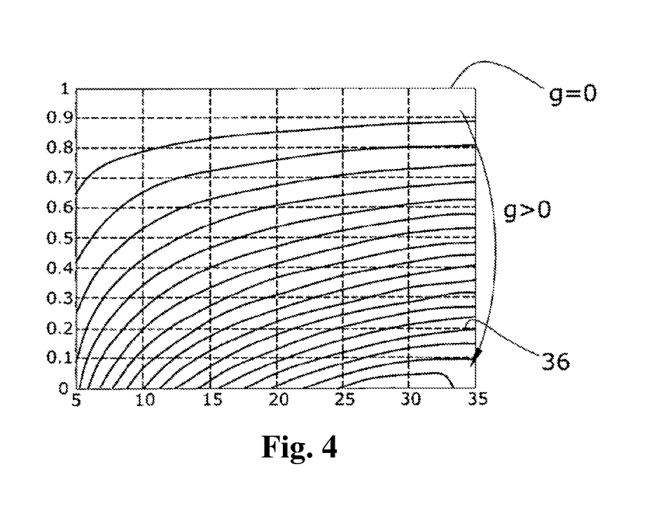

FIG. 4 illustrates a function of a second characteristic map.

FIG. 1 illustrates an exhaust gas mass flow sensor 10 for carrying out the present invention. The exhaust gas mass flow sensor 10 has its sensor head 14, which is arranged in an exhaust gas duct 12, provided with two sensor elements 15, 16 arranged in a row in the flow direction, i.e. following the arrow 11.

The first sensor element 15 is a pure temperature measuring element with which the temperature of the exhaust gas is determined. The second sensor element 16 is substantially formed by two separate temperature sensors 17, 18 arranged in a row in the flow direction, through which the temperature change is measured and the required power input is determined, respectively.

An electric connection 20, 21 connects each of both sensor elements 15, 16 with a control unit 22 which may in turn be connected with on-board electronics (not illustrated) via an electric connection 24. By means of the control unit 22, a temperature measurement by the first sensor element 15 is performed via the electric connection 20. At the same time, the second sensor element 16 or the two temperature sensors 17, 18 are heated via the electric connection 21. The temperature value supplied from the second sensor element 16 is formed by an arithmetic average of the respective measured temperature values of the first and the second temperature sensor 17, 18.

Further, an evaluation unit 28 is connected with the control unit 22 via an electric connection 26, the evaluation unit 28 storing characteristic maps 29, 30. The first characteristic map 29 is illustrated as an example in FIG. 3.

Here, the specific heat output is illustrated in mW/K in dependence on the summed mass flow \dot{M}_{Sum}=|\dot{M}_{for}|+|\dot{M}_{back}| in kg/h. The second characteristic map 30 stored in the evaluation unit 28 is illustrated as an example in FIG. 4. In this second characteristic map 30, the back flow portion

$$γ = \frac{{\dot{M}}_{back}}{{\dot{M}}_{for}}$$

is represented in dependence on the specific heat output in mW/K as a function of the normalized temperature gradient

$$g = \frac{{T}_{TS 2} - {T}_{TS 1}}{{T}_{SE 2} - {T}_{SE 1}} d .$$

FIG. 2 is an exemplary illustration of the time profile, in ms, of an exhaust gas mass flow in kg/h having a forward flow portion 32 and a back flow portion 34.

The method of the present invention will be described hereunder in an exemplary manner with reference to an exhaust gas temperature of 95° C.

Exhaust gas flows though the exhaust gas duct 12 as indicated by the arrow 11. At the first sensor element 15, which is a pure temperature measuring element, an exhaust gas temperature T_{SE1}=95° C. is measured, for instance. In a next step, the second sensor element 16 arranged downstream is heated to a mean temperature T_{SE2}=240 ° C., which temperature is higher than the temperature of the exhaust gas T_{SE1}=95° C. flowing by, so that the exhaust gas flowing past the second sensor element 16 causes a loss of heat. The power output by the second sensor element 16 is P=2.616 W, for example. From this, the specific heat output

$${P}_{Spec} = \frac{P}{{T}_{SE 2} - {T}_{SE 1}} = 18 , 041 mW \text{/} K$$

is obtained. From a stored first characteristic map 29, see FIG. 3, the value of the summed mass flow \dot{M}_{Sum}=|\dot{M}_{for}|+|\dot{M}_{back}| can be determined. The same is \dot{M}_{Sum}=33 kg/h. Further, the normalized temperature gradient is determined, with the temperature gradient being defined as the ratio of the temperature difference between a measured temperature value of a second and a first temperature sensor 18, 17 of the second sensor element 16 to the temperature difference between a temperature value obtained from the measured temperature values of the second sensor element 16 and a measured temperature value of the first sensor element 15. The same is

$$g = \frac{{T}_{TS 2} - {T}_{TS 1}}{{T}_{SE 2} - {T}_{SE 1}} = \frac{253 - 227}{240 - 95} = 0 , 18$$

and lies on the line 36 in FIG. 4. From the stored second characteristic map 30, see FIG. 4, the back flow portion

$$γ = \frac{{\dot{M}}_{back}}{{\dot{M}}_{for}}$$

is determined. The same is

$$γ = \frac{{\dot{M}}_{back}}{{\dot{M}}_{for}} = 0.$$

In a last step, the resulting total mass flow can be calculated using the formula

$${\dot{M}}_{restot} = {\dot{M}}_{Sum} \cdot \frac{( 1 - γ )}{( 1 + γ )} .$$

The same is

$${\dot{M}}_{restot} = 33 \cdot \frac{( 1 - 0 )}{( 1 + 0 )} = 33 kg \text{/} h .$$

1-6. (canceled)

7. A method for determining a resulting total mass flow to an exhaust gas mass flow sensor, the method comprising:
providing an exhaust gas mass flow sensor comprising a first sensor element and a second sensor element, the second sensor element comprising a first temperature sensor and a second temperature sensor, wherein the first sensor element and the second sensor element are arranged in a row in an exhaust flow direction and are configured to operate according to an anemometric principle;
determining a specific heat output at the exhaust gas mass flow sensor with the first sensor element and the second sensor element;
determining a value of a summed mass flow \dot{M}_{Sum}=|\dot{M}_{for}|+|\dot{M}_{back}| from a stored first characteristic map, wherein \dot{M}_{for} is a mass flow in a defined flow direction and \dot{M}_{back} is a mass flow opposite to the defined flow direction, a specific heat output being a function of the value;
determining a normalized temperature gradient, wherein the normalized temperature gradient is defined as a ratio of:
a temperature difference between a measured temperature value of the second temperature sensor and a measured temperature value of the first temperature sensor of the second sensor element to
a temperature difference between a temperature value determined by the second sensor element and a measured temperature value of the first sensor element;
determining a back flow portion
$$γ = \frac{{\dot{M}}_{back}}{{\dot{M}}_{for}}$$
from a stored second characteristic map, the back flow portion being a function of the specific heat output in dependence on the normalized temperature gradient; and
determining the resulting total mass flow according to a formula
$${\dot{M}}_{restot} = {\dot{M}}_{Sum} \cdot \frac{( 1 - γ )}{( 1 + γ )} .$$

8. The method as recited in claim 7, wherein, for determining the specific heat output at the exhaust gas mass flow sensor, the method further comprises:
determining a temperature of an exhaust gas with the first sensor element; and
heating the second sensor element arranged downstream of the first sensor element to a temperature which is higher than the temperature of the exhaust gas flowing by so that the exhaust gas flowing by the second sensor element causes a heat loss,
wherein the specific heat output is defined as a ratio of an output delivered by the second sensor element to a temperature difference between the second sensor element and the first sensor element.

9. The method as recited in claim 7, wherein the temperature value of the second sensor element is determined via an arithmetic average of the measured temperature value(s) of the first temperature sensor and the measured temperature value(s) of the second temperature sensor.

10. The method as recited in claim 7, wherein the second characteristic map is determined by experimentally determining, for a defined back flow portion, the specific heat output as a function of the normalized temperature gradient.

11. The method as recited in claim 7, wherein the first characteristic map is determined by experimentally determining the specific heat output from a defined summed mass flow.

12. The method as recited in claim 7, further comprising using the determined resulting total mass flow to optimize an engine control.

13. A method of using a total mass flow to optimize an engine control, the method comprising:
providing an engine control;
determining a resulting total mass flow as recited in claim 7; and
using the determined resulting total mass flow to optimize the engine control.

14. An exhaust gas mass flow sensor for carrying out the method as recited in claim 7, the exhaust gas mass flow sensor comprising:
an evaluation unit configured to store a first characteristic map and a second characteristic map;
a first sensor element; and
a second sensor element comprising a first temperature sensor and a second temperature sensor, the first temperature sensor and the second temperature sensor being arranged in a row in a flow direction,
wherein the first sensor element and the second sensor element are arranged in the row in the flow direction.
